(19) United States
(12) Patent Application Publication
(10) Pub. No.: US 2003/0122748 A1
(43) Pub. Date: Jul. 3, 2003

(54) Method for driving a passive matrix OEL device

(76) Inventor: Kuan-Jui Ho, Tainan (TW)

Correspondence Address: Rabin & Berdo, P.C., Suite 500, 1101 14th Street, Washington, DC, 20005, US

(21) Appl. No.: 10/026,437

(22) Filed: Dec. 27, 2001

(51) Int. Cl. G09G 3/32

(52) U.S. Cl. 345/82

(57) ABSTRACT

A method for driving an OLED using transistors as row drivers and data switches for a matrix OLED/PLED, in which a plurality of transistors as the data switches are driven in the saturation region, and a plurality of transistors as the row drivers are driven in the triode region. With this method the amount of current required to drive multiple pixels in the same row of an OLED/PLED during simultaneous illumination will not cause material change in voltage, but will remain constant. As such, pixels in the same row of an OLED/PLED are capable of reaching normal luminance or close to the value.

### BACKGROUND OF THE INVENTION

1. Field of the Invention

The present invention relates to a method for driving a passive matrix organic electroluminescence device (OEL), in particular, a driving method that enables multiple pixels located in the same row of OLED/PLED to be illuminated simultaneously with normal luminance.

2. Description of Related Art

OLED (organic light emitting device) is a molecule-based OEL (organic electroluminescent) device; while PLED (polymer light emitting diode) is a polymer-based OEL device. A matrix OLED panel is considered to be the next generation of display after the liquid crystal display, but only some small-panel OEL devices are being produced in commercial quantities.

With reference to the operating characteristic curve of an OLED in FIG. 3, when the voltage reaches the threshold level, luminance-voltage characteristic of the OLED will resemble the current-voltage characteristic (shown with a dotted line), provided that “voltage” is the control variable in these two characteristic curves.

Based on the principle V=IR, when working with a resistor-type OLED, it is only possible to choose one control variable, either “voltage” or “current”.

Still referring to the characteristic curve of the OLED in FIG. 3, provided that the input voltage is used to control light emission and luminance of the OLED, different values of the control voltage will cause changes in luminance corresponding to the current voltage characteristic curve. These changes can be observed with the human eye.

On the other hand, provided that the input current is used to control light emission and luminance of the OLED, different values of the control current will cause proportional changes in luminance, which is a direct relationship.

From the foregoing results, it is apparent that “current” is more preferable than “voltage” as a control variable when controlling the light emission of an OLED display.

Furthermore, at present, most passive matrix PLED displays available are of the small-panel type. The main characteristics of this type of display are that the matrix OLED panel is usually fitted with a small display panel and also the low cost is weighted heavily in the basic design. Accordingly, pulse width modulation (PWM) is the best method for controlling the gray scale of this type of display. With reference to a schematic circuit diagram of a passive matrix OEL device in FIG. 4, transistors Q1˜Q5 operate as data switches and row drivers. Based on the operating principles of PWM, switch-on time of a transistor is used to control the amount of energy passing through the transistor. Furthermore, the human eye has a tendency to sense the intensity of light with a time integral factor. Consequently, by controlling the amount of energy passing through an OLED in a unit of time, the luminance in gray scale can be accomplished.

However, if the amount of through current of each transistor is not constant under the PWM mode, the time factor alone is not adequate for the luminance adjustment. This is because the amount of energy passing through the transistor within the transistor switch-on time cannot be precisely controlled. Accordingly, the luminance control mentioned above becomes unreliable, and the actual implementation will require a very complicated control process.

To solve the foregoing problem, a proposal was made in U.S. Pat. No. 6,023,259 to use transistors as data switches in matrix OLED/PLED, through which the transistors can be driven in the saturation region (or so called the current region). The proposal claims that luminance control can be achieved by means of such a method. The main concept behind such a method is that the changes in current can be kept to the minimum for any change in voltage. With reference to the characteristic curve of a transistor in FIG. 5, if the transistor is to be driven in the saturation region, changes in current will be minimal for any voltage change. Thus, the control current can be regarded as a current source for the data switch in PWM mode.

However, when actually implementing the theory, some problems arise. With reference to FIG. 4, when the display area of an OLED panel is being expanded, the load on transistors Q4 and Q5 as row drivers will also increase proportionately. For the purpose of illustration, taking a small panel with 128×64 lines, each row of the OLED panel may have 0, 1, 2, . . . , to 128 transistors as the data switches, which may be illuminated all at one time. Since each transistor as the data switch draws the same amount of current (Id), the total amount of current supplied by transistor Q4 may range from 0, Id, 2×Id, . . . , to 128×Id. The voltage of transistor Q4 is not supposed to drop below the operating voltage. If the voltage drops substantially during this operation, even though all data switch transistors still operate in the current mode (saturation region), the amount of current passing through each data switch will be subject to change unpredictably due to the Early voltage or Channel width modulation effect. The current passing through each OLED, therefore, could not be controlled. Accordingly, luminance in the same row of pixels will not be uniform for the OLED display. Also, as the number of illuminated pixels is increased, luminance of each pixel will decrease proportionately, thereby degrading the image quality, resolution and contrast ratio.

From the foregoing discussion, even though U.S. Pat. No. 6,023,259 proposed using transistors as data switches with the transistors driven in the saturation region to keep the current change relatively small for any change in voltage, there are practical problems. When many pixels positioned in the same row of an OLED matrix are illuminated simultaneously, the voltage level is likely to drop, and the current mode is likely to change. Since all the foregoing questions were not addressed in their proposal, further research in these areas is necessary.

### SUMMARY OF THE INVENTION

The main object of a method for driving a passive matrix organic electroluminescence device (OEL) in accordance with the present invention is to provide a driver for a passive matrix OEL device by which a constant voltage can be maintained for any change in current. Accordingly, uniform luminance on the same row of pixels can be attained, even when multiple pixels in the same row of OLED are illuminated simultaneously.

The driving method comprises the steps of:

using a first plurality of transistors as row drivers for a matrix OLED/PLED;

using a second plurality of transistors as data switches for the matrix OLED/PLED;

using a PWM mode to control the row drivers and data switches; and

causing each transistor as the row driver to be driven in the triode region with high transconductance, such that the row driver is able to operate with minimal voltage change for any change in current. The pixels disposed in the same row of the matrix OLED will then be able to attain uniform luminance.

If a field effect transistor (FET) is used in the above-mentioned embodiment, the voltage (V_{GS}) across the gate terminal and source terminal of the transistor needs to be sufficiently high. When the current (I_{d}) is changed considerably, the voltage is only subject to small changes; thus a stable image is attained.

If a bipolar junction transistor (BJT) is used in the above-mentioned embodiment, the current at the base terminal (I_{B}) needs to be sufficiently large to maintain high transconductance value.

The objects, advantages and novel features of and methods used in the present invention will become more clearly understood when taken in conjunction with the accompanying figures.

### BRIEF DESCRIPTION OF THE DRAWINGS

FIG. 1 is a circuit diagram of the preferred embodiment to implement the method for driving a passive matrix organic electroluminescence device (OEL) in accordance with the present invention;

FIG. 2 is the characteristic curve of a MOSFET;

FIG. 3 is the characteristic curve of an OLED;

FIG. 4 is the circuit diagram of a conventional driver for a passive matrix OEL device; and

FIG. 5 is the characteristic curve of a transistor.

### DETAILED DESCRIPTION OF THE PREFERRED EMBODIMENT

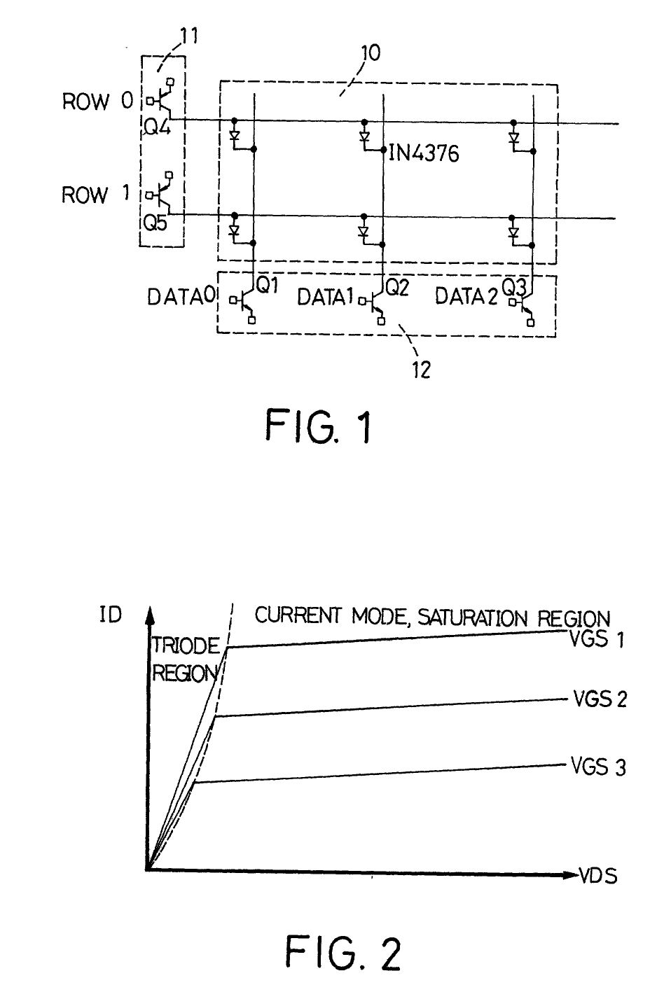

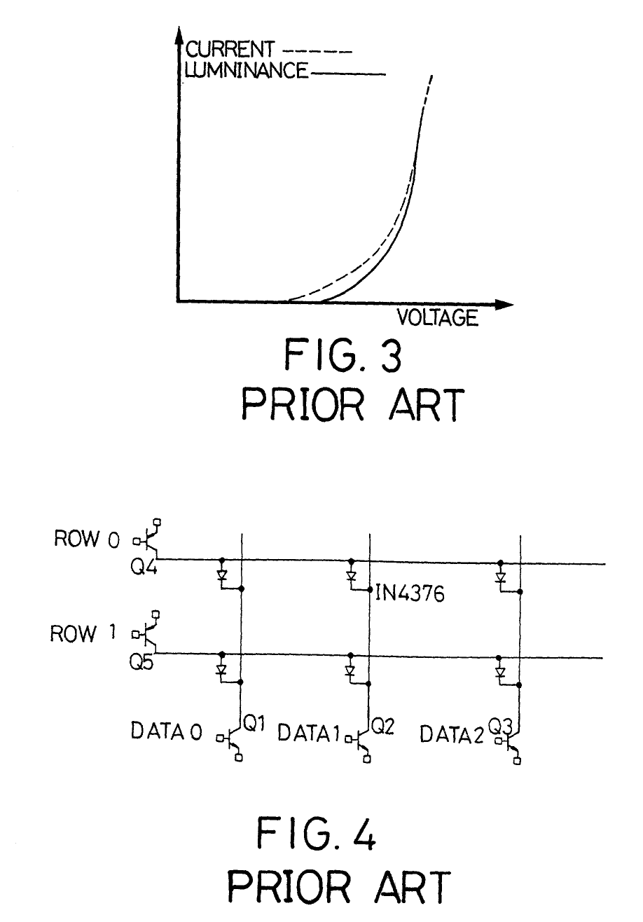

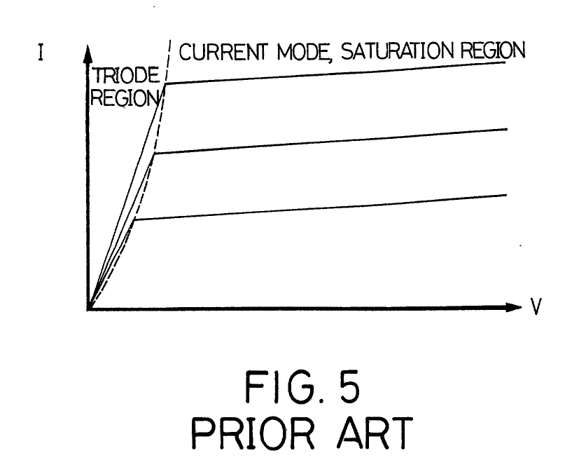

With reference to FIG. 1, in a method for driving a passive matrix organic electroluminescence device (OEL) in accordance with the present invention, single transistors Q1˜3 are used as data switches (12), and transistor Q4 and Q5 are used as row drivers (11). These current drivers are designed for driving a matrix OEL device. For the purpose of illustration, a matrix OLED (10) is used to represent the matrix OEL device mentioned above:

Two types of transistors can be used for building the necessary drivers: bipolar junction transistors (BJT) and MOSFET. The current-voltage characteristic of these two types of transistors are quite similar.

With reference to the current-voltage characteristic curve in FIG. 2, the voltage (V_{GS}) applied to the gate terminal of a MOSFET determines the current-voltage characteristic of the transistor, and the voltage (V_{DS}) appearing at the drain terminal controls the amount of current (I_{D}) passing through the transistor. When the V_{GS} is increased to a sufficiently high level to drive the transistor into the saturation region, current through the transistor will only vary slightly.

That is to say, if the MOSFET transistor for controlling the pixel illumination of OLED is to be driven in a current mode, it is necessary to cause the transistor to operate in the saturation region.

Although the characteristic curve of a BJT is quite similar to that of a MOSFET, the current rating of this transistor differs considerably. It therefore is not as good as a MOSFET for the OEL device application.

The basic characteristics of the transistors and the types of transistor suitable for driving a matrix OLED have been covered in the Summary. With reference to FIG. 1, the transistors Q1˜Q3 are used as data switches (12), and Q4 and Q5 are used row driver (11). The purpose of the method for driving a passive matrix organic electroluminescence device (OEL) in accordance with the present invention is to cause transistors Q1˜Q3 implementing the data switches (12) to be driven in the “saturation region”. Transistors Q4 and Q5 in the row driver (11) are to satisfy the constant voltage requirement for any current needed to drive multiple pixels in the same row of an OLED. The method causes the transistors Q4 and Q5 implementing the row drivers (11) to be driven in the “triode region”. With reference to FIG. 2 and using a MOSFET as an example, different voltage levels (Vgs) applied on the gate terminal will generate different Id−Vds characteristic curves. In general, these characteristic curves can be divided into two regions: the triode region and saturation region. The triode region on the left has a steep slope, whereas the saturation region on the right begins at a sharp bent in the slope of the curve. As disclosed above, the saturation region is when the voltage goes up, and the current varies very little. The triode region is when substantial change in current (Id) takes place, and the voltage change remains in a small range.

Using the characteristics mentioned above, the present invention causes the transistors Q4 and Q5 as row driver (11) to be driven in the triode region with high transconductance. If multiple pixels on the same row of an OLED are illuminated simultaneously, this will cause a substantial change in current and the voltage will only drop slightly. Under such conditions, the luminance of a row of pixels in OLED can be restored to normal luminance or close to the value.

The method causing the transistors to be driven in the saturation region or triode region can be expressed with the following formula:

For field effect transistors to be driven in the triode region, the mathematical formula is:

$${i}_{D} = K [ 2 ( {V}_{gs} - {V}_{t} ) {V}_{ds} - {V}_{ds}^{2} ] , and \frac{Δ id}{Δ Vds} = K [ 2 ( {V}_{gs} - {V}_{t} ) - 2 {V}_{ds} ]$$

For transistors to be driven in the saturation region, the mathematical formula is:

i_{D}=K(V_{gs}−Vᵢ)²(1+λV_{ds})

The operation curve of an OLED is:

$${i}_{D} = Is ( {ⅇ}^{\frac{Vd}{n * Vt}} - 1 )$$

Apart from the three mathematical formulae given above, the following characteristics should also be taken into consideration:

1. When a MOSFET is driven in the saturation region, if change in output voltage (Vds) is multiplied by a coefficient ( ) it then becomes change in current (Id). Hence when using a MOSFET for the current switching, if the current change is to be small for any change in voltage, then the coefficient has to be small.

2. When a MOSFET is used as a current source, the operation can be performed in the triode region. The Id−Vd relationship is represented by the secondary curve. When the amount of current changes, the corresponding voltage is subject to small changes, and it can be further compensated.

3. If the change in output voltage can be made to feedback to the transistor gate terminal of the row driver, and the transistor is driven in the triode region, more satisfactory results and easier control can be expected.

4. If a MOSFET is used, the voltage across the gate terminal and source terminal has to be sufficiently high, such that a substantial change in current would only cause a small change in the current, thereby a stable image quality can be attained.

5. If a BJT is used, the base current has to be sufficiently large in order to keep high transconductance.

In view of the advantages mentioned above, the method in accordance with the present invention is obviously superior to the conventional method in view of its practical value and progressive method. The preferred embodiment of the present invention is intended to be illustrative only, and under no circumstances should the scope of the present invention be so restricted.

What is claimed is:

1. A driving method for a passive matrix OEL device, comprising steps of:
using a first plurality of transistors as a row driver for a matrix OLED/PLED;
using a second plurality of transistors as data switches for the matrix OLED/PLED;
using a PWM mode to control the row drivers and data switches; and
causing each transistor of the row driver to be driven in the triode region with high transconductance, such that the row driver is able to operate with minimal voltage change for any change in current, and pixels disposed in the same row of the matrix OLED will then be able to attain uniform luminance.

2. The driving method for a passive matrix OEL device as claimed in claim 1, wherein the data switch transistors are driven in the saturation region.

3. The driving method for a passive matrix OEL device as claimed in claim 1, wherein each transistor is a MOSFET.

4. The driving method for a passive matrix OEL device as claimed in claim 2, wherein each transistor is a MOSFET.

5. The driving method for a passive matrix OEL device as claimed in claim 3, wherein the voltage across the gate terminal and the source terminal of the MOSFET is sufficiently high, such that when a substantial current change takes place, the corresponding voltage change will be minimal.

6. The driving method for a passive matrix OEL device as claimed in claim 1, wherein each transistor is a bipolar junction transistor.

7. The driving method for a passive matrix OEL device as claimed in claim 2, wherein each transistor is a bipolar junction transistor.

8. The driving method for a passive matrix OEL device as claimed in claim 6, wherein the base current in the row driver bipolar junction transistors is sufficiently large to maintain a high transconductance value.

9. The driving method for a passive matrix OEL device as claimed in claim 7, wherein the base current in the row driver bipolar junction transistor is sufficiently large to maintain a high transconductance value.
